(19) United States
(12) Patent Application Publication
(10) Pub. No.: US 2008/0222616 A1
(43) Pub. Date: Sep. 11, 2008

(54) Software translation

(75) Inventors: Stephen Ming Ko Cheng, Lower Hutt (NZ); Alex Potanin, Tawa (NZ); Christopher Michael Andreae, Aro Valley (NZ); Simon Marsh David Robinson, Johnsonville (NZ)

Correspondence Address: NIXON & VANDERHYE, PC, 901 NORTH GLEBE ROAD, 11TH FLOOR, ARLINGTON, VA, 22203, US

(73) Assignee: INNAWORKS DEVELOPMENT LIMITED, Lower Hutt (NZ)

(21) Appl. No.: 12/073,305

(22) Filed: Mar. 4, 2008

(30) Foreign Application Priority Data
Mar. 5, 2007 (NZ) 533614

(51) Int. Cl. G06F 9/45

(52) U.S. Cl. 717/137

(57) ABSTRACT

A computer implemented method for automatically translating a first source code associated with a first programming language to a second source code associated with a second programming language wherein the first and second source codes are associated with the same functionality, the method comprising the steps of: parsing the first source code to form a program structure representation comprising a plurality of program structure elements associated with the first programming language, analysing the program structure elements, wherein the analysis includes the step of searching for at least one program structure element that has no direct associated representation that produces the same result in the second programming language, and transforming the program structure representation into the second source code based on said analysis.

### FIELD OF INVENTION

This invention relates to the field of translating source code associated with one programming language to a second source code associated with a second programming language. In particular, the invention relates to the porting of an application written in Java or C# to C++ or C. Further, the present invention relates to software development and porting for mobile devices and embedded devices, where Java, C#, C and C++ are the programming languages.

### BACKGROUND

Mobile devices have become ubiquitous over the last few years. Mobile devices are now increasingly powerful, and most are capable of executing software applications.

There exist a multitude of software development platforms in the market for the mobile devices, including Java Micro Edition, BREW (Qualcomm Incorporated's Binary Runtime Environment for Wireless platform), Symbian, Microsoft Mobile, Microsoft CE, Palm OS as well as other various software development platforms.

Java Micro Edition is a very popular software development platform for mobile devices. According to some estimates, more than 60% of mobile devices worldwide are capable of executing software applications written for the Java Micro Edition platform. One variant of Java is the programming language used to write applications for the Java Micro Edition platform.

The primary programming languages for the software development platforms BREW, Symbian, Microsoft Mobile, Microsoft CE, Palm OS are C and C++. Although it is possible to develop for these platforms with other programming languages, they will be referred to in this application collectively as C/C++ based software development platforms.

The majority of mobile devices today are capable of running applications written for one and only one of the software development platforms. However some Symbian devices are also capable of running Java Micro Edition applications, and some Microsoft Mobile/Microsoft CE devices are also capable of running C# applications. To achieve a wider market penetration, it is a common practice for mobile software developers to provide their applications on Java Micro Edition, and one or more C/C++ based software development platforms.

There are a number of approaches to develop applications for Java Micro Edition and one of the C/C++ based software development platforms.

One such approach is known as “parallel development”. This essentially involves one development team developing software for the Java Micro Edition, while another development team would develop for another target platform in parallel. Although this approach has the advantage of rapid time to market, it is also very costly as it significantly increases the number of developers.

Another approach is known as “porting”. Essentially one development team develops the application for one particular software development platform. After the application is completed, it will be translated to, or otherwise modified for, the other software development platforms. The translation or porting process can be outsourced to a porting specialist company, which may be operating from a location with a lower cost base. Although this approach is typically more cost effective than parallel development, there is a significant increase in turn-around time, as well as a reduction of control of the quality of the ported application.

Another approach is known as “JVM bundling”. Essentially it involves bundling a Java virtual machine with the Java Micro Edition version of an application, such that it could run on one of the C/C++ based mobile development platforms. This approach has a number of major disadvantages, including relatively poor performance, high cost of licensing the Java virtual machine, high memory use and large download footprint, as well as the difficulty to leverage the special capabilities of the target mobile development platforms.

Previous known attempts to automatically translate from Java to C/C++, include Java2cpp by Programics (http://www.programics.com/java2cpp.php) and JCVM (http://jcvm.sourceforge.net/)

JCVM converts Java class files to C. However, this can result in the structure of the original source code being easily lost. Also, the JCVM generated source code is hard to understand compared to human written C++ code. In addition, comments are no longer available as they are not placed in the Java class files. Further, class hierarchy is lost as C does not directly support object oriented programming concepts.

Programic's java2cpp is an automated Java source code to C++ source code translator. Java2cpp is based on pre-processor technologies. However, Java2cpp is not capable of accurately translating some Java constructs and expressions common in Java source code. For example the try-catch-finally construct in the Java source code will result in the same construct in the C++ source code, although finally is not supported by C++. Due to the different order of evaluation rules in C++, and the inability in java2cpp to make necessary adjustments, expressions in the C++ source code may be evaluated differently from the original Java source code. In summary, Java2cpp output requires significant human effort to post-process after each translation attempt. The correction process is costly, time-consuming and negates the advantages of automated porting.

It is noted that there is a similarity between the Java and C# languages from the perspective of computer language analysis. The two languages share many common features, syntax, constructs and philosophy. As such methods and systems that facilitate translation from Java to C++ or C, can also be applicable to translations from C# to C++ or C.

### SUMMARY OF INVENTION

It is an object of the invention to provide an improved or at least alternative computer implemented method of translating from one source code in a first programming language to another source code in another programming language to provide substantially the same functionality.

In broad terms in one aspect the invention provides a computer implemented method for automatically translating a first source code associated with a first programming language to a second source code associated with a second programming language wherein the first and second source codes are associated with the same functionality, the method comprising the steps of: parsing the first source code to form a program structure representation comprising a plurality of program structure elements associated with the first programming language, analysing the program structure elements, wherein the analysis includes the step of searching for at least one program structure element that has no direct associated representation that produces the same result in the second programming language, and transforming the program structure representation into the second source code based on said analysis.

Also, the method may further comprise the steps of detecting at least one program structure element during the analysis step, and transforming the detected program structure element into a transformed program structure element that can be represented in the second programming language.

Further, the first programming language may be a programming language from the group comprising: Java; Java Micro Edition; C#; a language derived from Java; a language derived from C#, and the second programming language is a programming language from the group comprising: C; C++; a language derived from C; a language derived from C++.

Further, the second source code may be for a target platform from the group comprising: BREW; Symbian; Windows CE.

Further, the program structure representation may comprise an abstract syntax tree constructed from the first source code.

Further, a separate abstract syntax tree may be constructed for a single class.

Further, the program structure representation may comprise class hierarchy information constructed from the first source code.

Further, the second programming language may be a programming language from the group comprising: C; C++; a language derived from C; a language derived from C++, and the method may further comprise the steps of: compiling the second source code into a target object code, and linking the target object code with a first set of run-time libraries associated with the second programming language, wherein the first set of run-time libraries provide at least some of the capabilities of a second set of run-time libraries associated with the first programming language.

Also, the method may further comprise the steps of: analysing the program structure elements to identify expressions containing sub-expressions where the direct associated representation of the expression in the first programming language requires the sub-expressions to be executed in a specific order, but the direct associated representation of the expression in the second programming language does not, and converting an identified expression such that in the direct associated representation in the second programming language of the converted expression, the sub-expressions are executed in the specific order.

Further, the sub-expressions may be required to be operated on in the order from left to right. The expression may be a binary operator. The sub-expressions may be an argument list. The argument list may form part of a method or constructor invocation.

Further, the expression may comprise a first set of sub-expressions, and the expression is expressible in both the first and second programming language as one of the group comprising: language-defined operator; language-defined function; application-defined function, the method further comprising the steps of: extracting a first set of sub-expressions from the expression, and creating a new expression comprising the extracted sub-expressions such that the direct associated representation in the second programming language of the new expression produces the same result when executed as the execution of the direct associated representation of the original expression in the first programming language.

Also, the method may further comprise the step of using a temporary variable to store a result of one of the first set of sub-expressions.

Also, the method may further comprise the steps of: combining into the new expression, using the C sequence operator, one or more assignments to a temporary variable storing the result of a sub-expression of the first set in the required order of execution, and transforming the original expression with the sub-expression replaced by its corresponding temporary variable.

Also, the method may further comprise the step of: analysing the sub-expressions to determine if they are sensitive to the order in which they are evaluated and, upon a positive determination, creating the new expression.

Further, wherein the second programming language may be C++, or a language derived from C++, the method may further comprise the steps of: analysing the program structure representation to find a constructor method, wherein the constructor method is associated with a first class and a first set of parameters, creating a new method in the first class that has equivalent parameters to the first set of parameters, moving the logic embodied in the constructor method into the newly created method, and replacing an expression that instantiates the first class using the constructor and a set of arguments with an expression that instantiates the first class with a constructor and invokes the newly created method on the instantiated result with the set of arguments.

Further, wherein the second programming language may be C++, or a language derived from C++, the method may further comprise the step of: analysing the program structure representation to find an interface, wherein a class implements the interface, super-classes of the class do not implement the interface, the interface declares a method of a method signature, and the class does not define a method of the method signature, and there exists a super-class of the class that does define a method of the method signature.

Also, the method may further comprise the step of: adding to the class a method with the method signature the behaviour of which is to invoke the method of the method signature in the super-class.

Also, the method may further comprise the steps of: determining if the class is an abstract class, and, upon a positive determination, and adding to a concrete subclass of the class a method with the method signature the behaviour of which is to invoke the method of the method signature in the super-class.

Further, wherein the second programming language may be C++, or a language derived from C++, the method may further comprise the steps of: analysing the program structure representation to find a nested class, extracting the nested class from an enclosing class to a non-nested class, and associating the extracted nested class with the previously enclosing class.

Further, wherein the extracted nested class may be associated with the previously enclosing class by marking each class as a friend of the other.

Also, the method may further comprise the steps of: analysing the program structure representation to find an inner class associated with the first source code, modifying the inner class by adding a field referring to the previously enclosing class, and adding additional parameters to constructor methods of the inner class denoting the outer class.

Further, wherein where the inner class may be a local inner class or anonymous inner class, the method may further comprise the step of adding extra construction parameters and fields to the inner class denoting the final local variables of the enclosing method.

Further, wherein the second programming language may be C++, or a language derived from C++, the method may further comprise the steps of: analysing the program structure representation to find an array initializer, and upon finding, and transforming the array initializer to a form suitable for representation in the second source code.

Also, the method may further comprise the steps of: creating a method that creates an array, initializes the contents of the created array using parameters to the method corresponding to the elements contained in the array initializer, and returns the created array, and replacing the array initializer with an invocation of the method, the arguments of which are the original elements contained in the array initializer.

Further, wherein the second programming language may be C++, or a language derived from C++, the method may further comprise the steps of: analysing the program structure representation to identify the use of any non-primitive arrays of any dimension associated with the first source code, and replacing references to any non-primitive array types associated with the first source code with references to a class representing more than one non-primitive array types, wherein the class is associated with the second source code.

Further, wherein an instance of the class may contain information pertaining to an element type and dimension of the array it represents.

Also, the method may further comprise the step of: modifying the signature of methods with one or more parameter types or return type which is a non-primitive array type, resulting, after the replacement of references, in a signature that is based on the original declared element type and dimension of each of the non-primitive array type parameter or return types in order to eliminate or reduce the possibility of name conflicts.

Also, the method may further comprise the step of: replacing: creations of reads from, writes to or type test and cast operations on instances of non-primitive array types associated with the first source code with expressions performing an equivalent operation on the non-primitive array class associated with the second source code.

Also, the method may further comprise the steps of: analysing the program structure representation to find any static initialization component associated with the first source code, modifying the static initialization component to create a representation suitable for the second programming language, and invoking the modified static initialization component.

Also, the method may further comprise the steps of: analysing the program structure representation to find any static initialization component for a class associated with the first source code, modifying the class by adding a method to the class, the method having the same function as the static initialization component, removing the static initialisation component, and finding a location involving use of static fields of the class, invocation of the static methods of the class or an instantiation of the class.

Further, whereupon finding a static initialization component, the method may further comprise the steps of: inserting instructions immediately before the location to determine whether the class has completed static initialisation, and if static initialisation has not been completed, invoking the added method, and registering that the class has completed static initialisation.

Also, the method may further comprise the step of: determining if the static initialization component has any effect that would result in different behaviour of the program if it were evaluated at a point in program execution other than the first encounter of one of the locations of claim 34, and, upon a positive determination, causing the static initialization component to be evaluated at a different time.

Also, the method may further comprise the steps of: analysing the program structure representation to find any instance initialization component associated with the first source code, modifying the instance initialization component to create a representation suitable for the second programming language, and invoking the modified instance initialization component.

Also, the method may further comprise the steps of: analysing the program structure representation to find any instance initialization component for a class associated with the first source code, modifying the class by adding a method to the class, the method having the same function as the instance initialization component, removing the instance initialization component, and inserting an invocation of the method at the beginning of a constructor.

Also, the method may further comprise the steps of: analysing the program structure representation to find class hierarchies containing original classes associated with the first source code, and, if found, modifying the original classes to merge classes together in order to reduce the number of classes associated with the second source code.

Also, the method may further comprise the steps of: determining if the original classes can be merged to form a second source code that has substantially the same functionality as the first source code, and upon a positive determination, modifying the program structure representation to merge the original classes to form a new single class by moving the class elements, and modifying any references to the original classes such that they refer to the new single class.

Further, wherein the original classes may be merged such that a first original class is merged into a second original class.

Further, wherein the original classes may be merged such that first and second original classes are merged into a new class.

Further, wherein it may be determined whether elements in the first original class conflict with elements in the second original class.

Also, the method may further comprise the steps of: determining if the original classes to be merged include a class and its direct super-class, and the direct super-class has only one subclass and is non-instantiated, and, upon a positive determination, merging the super-class and class, and replacing references to the class and the super-class with reference to the merged class.

Further, wherein an interface may be considered a class, the method may further comprise the steps of: determining if the original classes to be merged include a class and an interface that the class directly implements, wherein the interface is directly implemented by the class or its subclasses, but not directly implemented by any other classes, and the interface is not extended by any other interfaces, and, upon a positive determination, merging the interface with the class, replacing references to the interface with references to the class, and removing the implementation of the interface from any subclass that implements the interface.

Also, the method may further comprise the steps of: determining if the original classes to be merged include a first class and a second class, wherein the first class is a direct subclass of a root class of the class hierarchy, the second class is not an interface, and the first class has no non-static fields, no non-static methods and no subclasses, further determining by static analysis if a class initializer associated with the first class has no side-effects, or can be performed such that it would result in different program behaviour if it were evaluated in a different order with respect to the class initializer associated with the second class, and, upon positive determinations, merging the first and second classes, and replacing references to the first class and the second class with references to the merged first and second classes.

Further, wherein the first set of run-time libraries may include an implementation of automatic garbage collector.

Further, wherein the first set of run-time libraries may include a co-operative thread scheduler.

Further, wherein the second source code may retain the comments from the first source code by transforming the comments in the program structure representation to a format associated with the second source code.

According to a second aspect, the present invention provides a computer implemented method for automatically translating an exception functionality in a first source code associated with a first programming language to an equivalent exception functionality in a second source code associated with a second programming language wherein the first and second source codes are associated with the same functionality, the method comprising the steps of: analysing a program structure representation of a first source code in order to find a program structure element that is associated with an exception functionality, determining if the analysis step has found an exception functionality, and, upon a positive determination, and converting the exception functionality to a suitably equivalent exception functionality in the second source code.

Further, wherein the order in the second source code of any components of the converted exception functionality may be the same as the order in the first source code of the equivalent components of the exception functionality.

Further, wherein the elements of the exception functionality may be contiguous in the first source code, and the elements of the converted exception functionality in the second source code may be contiguous in the second source code.

Further, wherein the first programming language may be Java and the exception functionality in the first source code may be a try/catch/finally statement.

Also, the method may further comprise the steps of: determining if there exists an occurrence of control flow which would exit a try region and cause a finally region to be executed in the first programming language, and, upon a positive determination, using in the second source code one or more means of storage to record the type of control flow, including a continue, break or return expression or an exception, by which the try region was exited, executing instead the finally region, and subsequently using the stored information to provide equivalent functionality of control flow in the second source code as the functionality when the finally block exits in the first source code.

Also, the method may further comprise the steps of: saving the original control flow immediately before an expression establishing the original control flow by means of at least one of the functions in a group consisting of: setjmp( ) in the C programming language; getcontext( ) in the POSIX API for the C programming language; a function producing substantially the same effect as setjmp( ) or getcontext( ); and resuming the original control flow after the finally region is executed to return to the expression establishing the original control flow by means of at least one of the functions in a group consisting of: longjmp( ) in the C programming language; setcontext( ) in the POSIX API for the C programming language; a function producing substantially the same effect as longjmp( ) or setcontext( ).

Further, wherein the means of storage may include one of a field or a local variable.

Also, the method may further comprise the step of: converting the try/catch/finally statement to a mechanism in the second source code using a method to store the current state of the program and a method to restore the state.

Also, the method may further comprise the step of: converting the try/catch/finally statement to a mechanism in the second source code using one of the group consisting of: setjmp( ) in the C programming language; longjmp( ) in the C programming language; setcontext( ) in the POSIX API for the C programming language; getcontext( ) in the POSIX API for the C programming language.

Also, the method may further comprise the step of: defining any local variables modified inside the try block in the first source code as volatile local variables in the second source code.

Further, wherein the second programming language may be C++, or a language derived from C++, the method may further comprise the steps of: determining if, for a method of a method signature in a first class, a method invocation of that signature on an object reference whose declared type is the type of the first class could result in polymorphic method dispatch to any method other than the method, and, upon a negative determination, translating the method to a translated method in the second source code that is not marked as virtual.

Further, wherein the determination step may further comprise: determining whether the method is not private, not abstract, and there exists no non-private method of the method signature in any class or interface that is a supertype or subtype of the first class.

The current invention provides a means to automatically translate an application written in a first programming language, such as Java to a second programming language, such as C/C++, essentially with no post-processing required. With the current invention, only one development team is required to code the application in Java Micro Edition, and simultaneously through applying the current invention an equivalent C/C++ version can be created. As a result this approach delivers a rapid time to market and increased cost effectiveness over the prior art.

The translated source code using the current invention is more understandable, maintainable by the original developers, and easier to debug, resulting in reduced development, testing and maintenance costs.

### BRIEF DESCRIPTION OF THE DRAWINGS

The invention is further described with reference to the accompanying drawings which show a preferred computer implemented method of the invention, by way of example and without intending to be limiting. In the drawings:

FIG. 1 is a perspective view of a computing system for implementing the preferred method,

FIG. 2A shows a first portion of a flow diagram of the process associated with the computer implemented method according to a preferred embodiment,

FIG. 2B shows a second portion of a flow diagram of the process associated with the computer implemented method according to a preferred embodiment,

### DETAILED DESCRIPTION OF PREFERRED EMBODIMENT

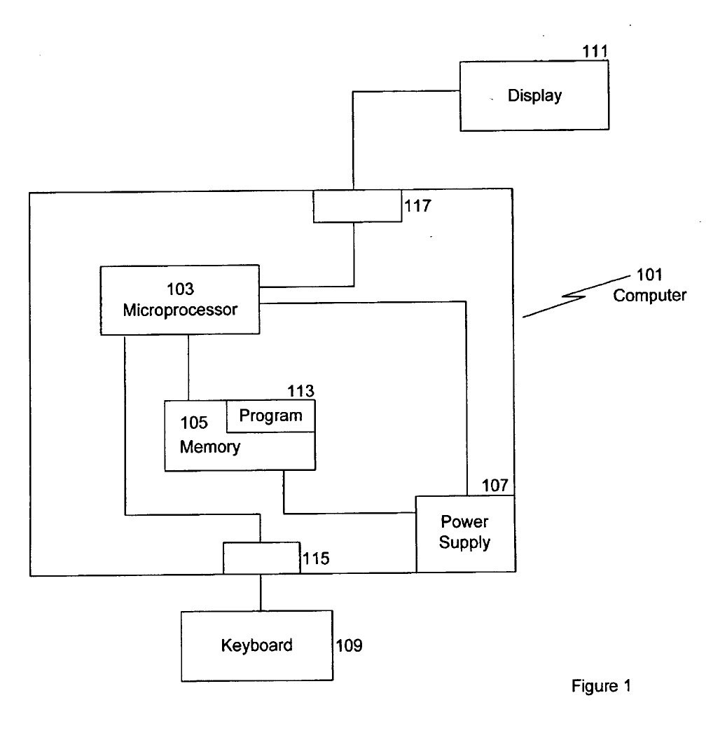

Referring to FIG. 1 the computer implemented method is executed on a system that includes a computer 101 with a microprocessor 103, memory 105 and a power supply 107 to provide power to the respective elements of the computer 101. Attached to the computer are input and output devices, such as a keyboard 109 and display monitor 111, which are connected to the computer via interfaces (115, 117).

The method is implemented by the microprocessor 103 executing a computer program 113 residing in the memory 105. Alternatively, the program may reside in an external memory device.

Other programs are provided to allow compiling and linking of object code to enable the production of programs associated with the source code in the required languages.

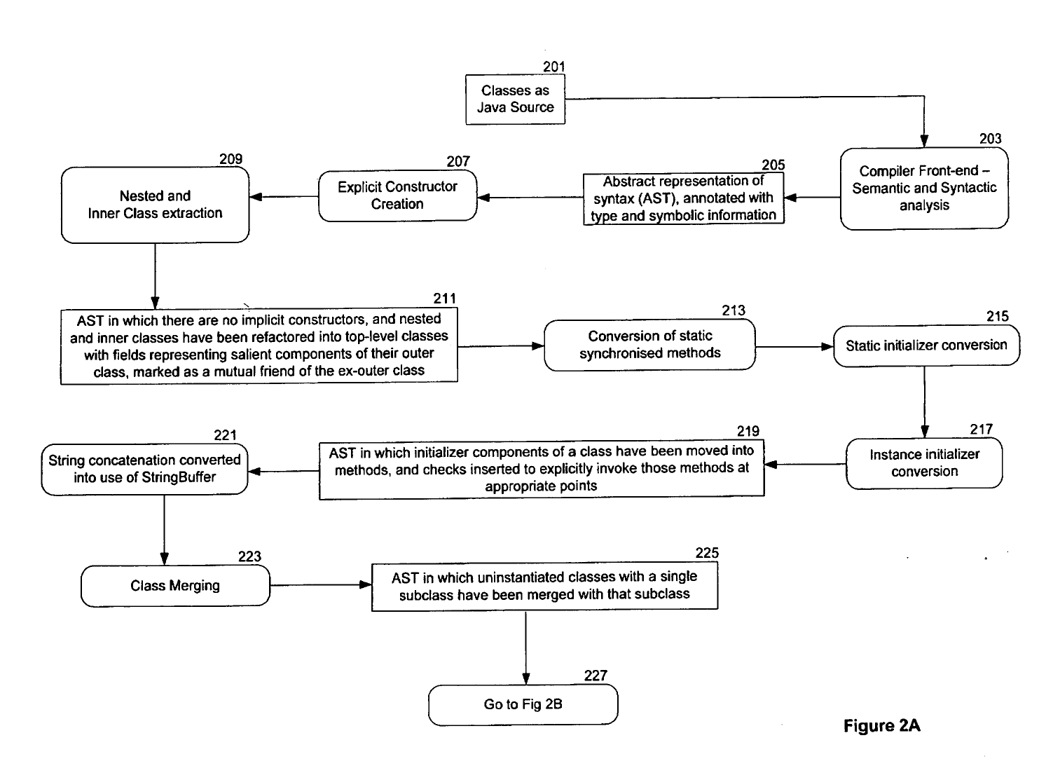

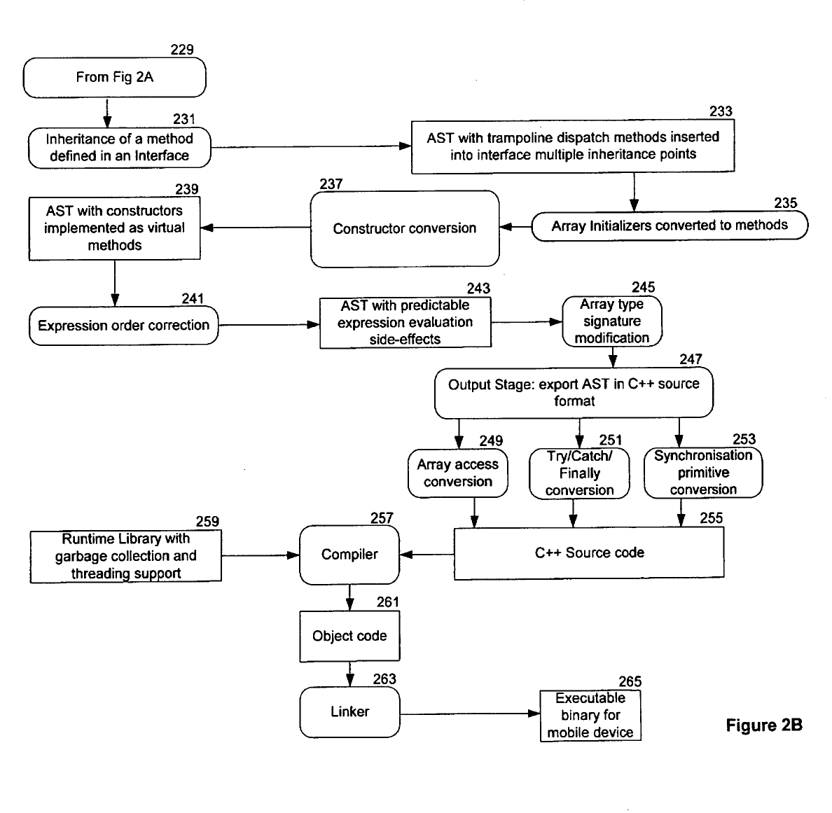

Referring to FIG. 2A, the computer implemented method for translating source code intended for use in one language to a second language includes the following processes.

At step 201 the classes are defined in Java source code. At step 203, compiler front end semantic and syntactic analysis is performed. This produces, at step 205, an abstract representation of syntax (AST), annotated with type and symbolic information. At step 207, explicit constructors are created. At step 209, nested and inner class extraction is performed. At step 211, the AST has no implicit constructors, and nested and inner classes have been refactored into top-level classes with fields representing salient components of their outer class, marked as a mutual friend of the ex-outer class. At step 213 the conversion of static synchronised methods is performed. At step 215 the conversion of static initializers is performed. At step 217, the conversion of instance initializers is performed. Thus, at step 219, the AST has had initializer components of a class moved into methods, and checks inserted to explicitly invoke those methods at appropriated points. At step 221, string concatenation is converted into StringBuffer. Class merging is carried out at step 223. At step 225, an AST is provided in which uninstantiated classes with a single subclass have been merged with that subclass. The procedure then moves to FIG. 2B.

Referring to FIG. 2B, the method continues from step 229 with the following processes. At step 231, the step to correct inheritance of a method defined in an interface is performed. Such that, at step 233, the AST includes “trampoline” dispatch methods inserted into interface multiple inheritance points. At step 235, array initializers are converted to methods. At step 237, the step to convert constructors is performed. At step 239, the AST includes constructors implemented as regular methods. At step 241, expression order correction is performed. At step 243, the AST includes predictable expression evaluation side-effects. At step 245, array type signature modification is performed. At step 247, the AST is exported in C++ format. At step 249, array access conversion is performed. At step 251, try/catch/finally conversion is performed. At step 253, synchronisation primitive conversion is performed. This results in the final C++ source code at step 255, which is forwarded to a compiler 257. A runtime library 259 is accessed by the compiler. Object code is created at step 261, and linked at step 263 to provide executable binary code for a mobile device at step 265.

Detailed examples of the translation process for different program structure elements forming the program structure representation of the parsed source code are now provided.

In each of the following examples, the original source code is parsed and a program structure representation is produced in the form of an abstract syntax tree (AST). The AST includes a number of original language program structure elements that are associated with the original programming language. The AST is also capable of representing program structure elements that are associated with a target programming language. It will be understood that program structure representations other than an AST may be utilised.

The AST is analysed by a program in order to modify any program structure elements that require modification in order to produce a target program in the target programming language, such that the target program operates in the same desired manner as the original programming language.

That is, the program structure representation is analysed to find specific program structure elements that fall into a defined group. The group consists of program structure elements that have no direct associated representation in the second programming language. That is, a direct associated representation is a straight forward and direct mapping from the AST to the source. Also, the original programming language may provide a specific functionality that the target programming language does not provide, such that there is no direct associated representation of the program structure element for that functionality in the target programming language. For example, when using the program structure element in association with the target programming language, the target programming language may produce a different result, such as a different program state, to the result produced by the original target language for the same program structure element.

In one example, as will be explained in more detail below, the program structure elements may be analysed to identify expressions containing sub-expressions where the direct associated representation of the expression in the first programming language requires the sub-expressions to be executed in a specific order, but the direct associated representation of the expression in the second programming language does not. Therefore, conversion of the identified expression is required such that in the direct associated representation in the second programming language of the converted expression, the sub-expressions are executed in the specific order.

Different methods of conversion are provided depending on the type of program structure elements that require conversion.

After conversion the AST is exported in the target programming language format.

Finally, during the exportation of the AST, a method is provided for converting exception handling functionalities, as will be explained later.

In the preferred embodiment, a conversion is made from Java to C++.

A design for a Java to C++ translator is as follows.

The translator has three stages:
1. Parse Java source code to a language-independent internal program structure representation (AST). Further, class hierarchy information is also generated.
2. Transform the AST structure so that it may be output as C++ source.
   a. Find all program structure elements in the AST that have no representation in C++ source code, and transform them into semantically equivalent program components using only elements available in C++ source.
   b. Find all program structure elements in the AST whose representation in C++ source code has different runtime semantics to the Java equivalent, and transform the structure in such a way that the desired semantics are obtained.
3. Generate the C++ source code from the AST.

Java source code is read using a parser into an Abstract Syntax Tree (AST). This AST model must be capable of representing the Java language, those features in the C++ language which have a direct analogue in Java, and several C++ language features that are not present in Java, such as sequencing expressions, explicit pointer and reference use, and non-virtual method calls. As the AST is read in the program is type-checked, and the tree is annotated with type and symbolic (that is, the program entity referred to by a given identifier) information. Further, class hierarchy information is generated. Further, comments in the source code are also included as metadata in the AST. The overall task of translation is to transform those sections of the initial parse of the Java program AST that are not representable with the same semantics in C++ into an AST representation of valid C++ code, and then to output the AST as C++ source.

The following steps are taken to effect this transformation of the abstract syntax tree:
a. All classes with default (implicit) constructors have explicit constructors created according to the definition of default constructors (Java Language Specification 3 ed §8.8.9). Implicit super-constructor calls are also made explicit.
b. Inner classes are extracted from their parent class.
c. Static initializers are converted into methods.
d. Instance initializers are converted into methods.
e. String concatenation operators are converted to uses of the StringBuffer class as described in the Java specification (JLS 15.18.1.2).
f. Class merging is performed.
g. “Trampoline” dispatch methods are inserted into interface multiple inheritance points.
h. Array initializers are converted to methods.
i. The bodies of constructors are extracted to separate virtual methods to permit virtual dispatch.
j. Expressions in the AST are modified to strictly enforce the left-to-right sub-expression evaluation order used by Java.
k. Array type signature modification. Type signatures of methods involving array typed arguments are modified to prevent name conflict when arrays are converted to use a single class.
l. Devirtualisation optimisation is performed.

The AST is then output as C++ source format. For each class C in the AST, a header file and a source file named after the class are created. The header file is initialized with #include directives for the runtime library and for the header file of each class which is statically referenced by code in the interface of C. The source file is initialized with a #include directive for the header, and for the header file of each class which is statically referenced by code in the body of C. A C++ class declaration is created for the class C, defined as extending the superclass and interfaces of C, and output into the header file. For each method and field in C, a C++ declaration for that method or field is added to the class declaration in the header file.

For each method in C, a method definition is created in the source file to match the corresponding declaration in the header file if the method is not pure virtual. The AST structure of the body of the method is traversed to produce a C++ representation, which is output as the body of the method definition in the source file. Comments in the AST are also included at the translated equivalents of their position in the original source code. Most remaining AST constructs in method bodies have either a direct representation in C++, or a simple direct translation to a construct with a direct representation in C++ which may be performed during output. The following more complex translations are also performed during this source output phase:
a. Try/catch/finally are transformed.
b. Object array creation and access modification.

The resulting C++ source is compiled against a runtime library which provides the API expected by the translated code, including an automatic garbage collector and co-operative threading and synchronization support. This compiled code is finally linked to produce a binary which can be used on the target device.

Constructor Normalisation

This step is a process of normalisation in the AST. For each class C in the AST, if C declares no constructor methods, then a default constructor must be created. Create a public constructor method M for C with no parameters. Add as the only statement in M an explicit super-constructor invocation statement with no arguments. If C declares constructor methods, then implicit super-constructor invocations in those methods must be made explicit. For every constructor method M in C, if the first statement in the body of M is not a constructor invocation, then add as the first statement in M an explicit super-constructor invocation statement with no arguments.

Nested and Inner Class Extraction

There are two groups of nested classes. The first group consists of static nested classes wherein an outer class textually encompasses a class that is declared as static. A nested class has access to the private static members of the enclosing class. Many C++ compilers do not support nested classes, or support them in a way that is different from Java. The second group is an inner class, which is a non-static nested class.

The Java programming language supports a feature known as ‘Inner Classes’ (Java Language Specification (3^{rd} edition), §8.1.3), which has no direct analogue in C++. An inner class is a class whose definition is nested within the body of or a method of another ‘enclosing’ class, which violates the expectations for normal classes by:
having access to private members of enclosing classes and vice-versa;
having access to an enclosing instance variable;
being able to access that enclosing instance implicitly or by using a qualified this;
having access to the super-class elements of enclosing classes, via qualified this and super statements; and
having access to final local variables of the enclosing method(s), in the case of local and anonymous classes.

It is necessary to convert the inner class into a normal class that can be represented in C++.

Inner Class Extraction Procedure

An example of a procedure to convert the AST representation of an inner class I enclosed by a class O into a class which meets the requirements to output as a C++class is as follows:
1. Make the enclosing instance explicit:
   a. Add an instance field outer of type O to I in which to store a reference to the enclosing instance;
   b. Add a parameter of type O to each constructor of I, and code to either store the value passed to this parameter in the field outer, or pass it to another explicitly invoked constructor. If I defines no explicit constructors, first create an explicit default constructor (JLS 3ed. §8.8.9).
   c. Alter invocations of the constructors of I to pass the enclosing instance to the added parameter.
      i. In the case of unqualified new-invocations within O, the enclosing instance is this;
      ii. In the case of qualified new-invocations, the enclosing instance is the qualifying expression;
      iii. In the case of an explicit constructor invocation from another constructor, the enclosing instance is the corresponding enclosing instance argument of the calling constructor.
2. Refactor use of implicit and qualified-this references to the enclosing instance of O within the body of I to instead explicitly use the field outer.
3. Refactor qualified-super references to the enclosing instance of O within the body of I to explicitly call the specified method in the supertype of O. An explicit non-virtual call is legitimate in C++ (for example, var.TypeName::method(args)), but not in Java, and must be supported by the AST abstraction.
4. Method-local or anonymous inner classes may access final local variables that are declared in the enclosing method of the enclosing class. If I is a method-local or anonymous inner class in method O.m, make its use of final local variables explicit: for each final local variable declared in m that is used in I, follow the procedure described in 1. to add an instance field and constructor parameters to I to store that variable, and alter uses of that variable in the AST of O to refer to the new field.
5. If I is an anonymous inner class, then create a non-conflicting top-level name for I.
6. Remove I from O, making it a non-nested class with a valid top-level name, and update AST nodes which refer to the type explicitly (such as new instance creation) to reflect the new location of the type.
7. Mark I and O as ‘friend classes’ of one another. This construct is valid in C++ code but not in Java, and must be supported by the combined AST abstraction.

This procedure is recursively applied in the case of multiply-nested inner classes.

Nested Class Extraction Procedure

An example of a procedure to convert the AST representation of an nested class N enclosed by a class O into a class which meets the requirements to output as a C++ class is as follows:
1. Remove N from O, making it a non-nested class with a valid top-level name, and update AST nodes which refer to the type explicitly (such as new instance creation) to reflect the new location of the type.
2. Mark N and O as ‘friend classes’ of one another. This construct is valid in C++ code but not in Java, and must be supported by the AST abstraction.

### EXAMPLES

Examples are given as a pseudo-Java textual rendering of the AST, using C++ style to represent constructs that are not valid in Java. In particular, this includes use of the keyword friend to mark a class as a C++ friend of another, placed in the pseudo-Java source immediately after the definition of the class name.

Simple Inner Class

This is a simple example, showing constructor insertion and translation.

| | |
|---|---|
| Before | class SimpleOuter{ |
| | class SimpleInner{ } |
| | void amethod( ){ new SimpleInner( ); } |
| | } |
| After | class SimpleOuter friend SimpleOuter_SimpleInner{ |
| | void amethod( ){ |
| | new SimpleOuter_SimpleInner(this); |
| | } |
| | } |
| | class SimpleOuter_SimpleInner friend SimpleOuter{ |
| | private SimpleOuter outer; |
| | public SimpleOuter_SimpleInner(SimpleOuter outer){ |
| | super( ); |
| | this.outer = outer; |
| | } |
| | } |

Inner Class Accessing Enclosing Instance Methods

This is a more complex example, showing use of enclosing instance methods.

| | |
|---|---|
| Before | public class Outersuper{ |
| | public int f( ){return 5;} |
| | public int g( ){return 15;} |
| | } |
| | public class Outerclass extends Outersuper{ |
| | public int f( ){return 6;} |
| | public int g( ){ return 16;} |
| | class Inner{ |
| | public int f( ){ return 8; } |
| | public int testmeth( ){ |

| | |
|---|---|
| if(f( ) != 8) | return 1; |
| if(this.f( ) != 8) | return 2; |
| if(Outerclass.this.f( ) != 6) | return 4; |
| if(Outerclass.super.f( ) != 5) | return 5; |
| if(g( ) != 16) | return 8; |
| if(Outerclass.this.g( ) != 16) | return 9; |
| if(Outerclass.super.g( ) != 15) | return 10; |
| return 0; | |
| } | |
| } | |
| } | |

| | |
|---|---|
| After | public class Outersuper{ |
| | public int f( ){return 5;} |
| | public int g( ){return 15;} |
| | } |
| | public class Outerclass extends Outersuper |
| | friend Outerclass_Inner{ |
| | public int f( ){return 6;} |
| | public int g( ){ return 16;} |
| | } |
| | class Outerclass_Inner friend Outerclass{ |
| | private Outerclass outer; |
| | public Outerclass_Inner(Outerclass outer){ |
| | this.outer = outer; |
| | } |
| | public int f( ){ return 8; } |
| | public int testmeth( ){ |

| | |
|---|---|
| if(f( ) != 8) | return 1; |
| if(this.f( ) != 8) | return 2; |
| if(outer.f( ) != 6) | return 4; |
| if(outer.Outersuper::f( ) != 5) | return 5; |
| if(outer.g( ) != 16) | return 8; |
| if(outer.g( ) != 16) | return 9; |
| if(outer.Outersuper::g( ) != 15) | return 10; |
| return 0; | |
| } | |
| } | |

Anonymous Inner Class Using Final Local Variables

| | |
|---|---|
| Before | public class Outer{ |
| | public Object hashcodeObject(final int code){ |
| | return new Object( ){ |
| | public int hashCode( ){ return code; }; |
| | }; |
| | }} |
| After | public class Outer friend Outer_InnerClass1{ |
| | public Object hashcodeObject(final int code){ |
| | return new Outer_InnerClass1(this, code); |
| | } |
| | } |
| | class Outer_InnerClass1 friend Outer{ |
| | private Outer outer; |
| | private int code; |
| | public Outer_InnerClass1(Outer outer, int code){ |
| | this.outer = outer; |
| | this.code = code; |
| | } |
| | public int hashCode( ){ return code; }; |
| | }; |

Multiple Nested Inner Classes

| | |
|---|---|
| Before | class L1{ |
| | int code( ){ return 1; } |
| | class L2{ |
| | int code( ){ return 16 + L1.this.code( ); } |
| | class L3{ |
| | int code( ){ return 256 + L2.this.code( ) + |
| | L1.this.code( ); } |
| | } |
| | } |
| | } |
| After | class L1 friend L1_L2{ |
| outermost | int code( ){ return 1; } |
| class | } |
| transformed | class L1_L2 friend L1{ |
| | private L1 outer; |
| | public L1_L2(L1 outer){this.outer = outer;} |
| | int code( ){ return 16 + outer.code( ); } |
| | class L3{ |
| | int code( ){ return 256 + L1_L2.this.code( ) + |
| | outer.code( ); } |
| | } |
| | } |
| After both | class L1 friend L1_L2{ |
| classes | int code( ){ return 1; } |
| transformed | } |
| | class L1_L2 friend L1, L1_L2_L3{ |
| | private L1 outer; |
| | public L1_L2(L1 outer){this.outer = outer;} |
| | int code( ){ return 16 + outer.code( ); } |
| | } |
| | class L1_L2_L3 friend L1_L2{ |
| | private L1_L2 outer; |
| | public L1_L2_L3(L1_L2 outer){this.outer = outer;} |
| | int code( ){ return 256 + outer.code( ) + |
| | outer.outer.code( ); } |
| | } |

Static Initializer Conversion

The term static initialisation component used in this description is to be understood to mean the initializer expression of a static field, or a static initialization block. The Java programming language includes the concept of “Static Initialisation” (Java Language Specification (3^{rd} edition), §12.4). When a class T is first accessed statically, that is, when:
a subclass of T must be initialized;
an instance of T is created;
a static method declared by T is invoked;
a static field declared by T is assigned; or
a static field declared by T is used and the field is not a constant variable, (JLS 3e §12.4.1)

T is initialized by executing its static initializer blocks and the initializer expressions of its static variables in textual order.

The C++ language has no equivalent construct to static initializer blocks, and static variable initializers are executed in an implementation-defined order before the main( ) function. It is therefore necessary to convert static initializers in a Java program before they can be accurately represented by C++.

Conversion Procedure

An example of a conversion procedure is as follows:

```
Let INIT_SIG be the method signature “public static void
static_initializer( )”
For each class T in the AST, do:
  Initialize ordered list L as empty;
  For each element E of T in textual order do:
    If E is a static block, then:
      Remove E from T;
      Append E to L;
      Remove static modifier from E;
    Else if E is a static field declaration with a non-constant initializer
      expression X, then do:
        Remove X from E;
        Create an assignment node N whose left-hand side is a
          reference to the field declared by E, and right-hand side is X;
        Append a new statement containing the expression N to L;
  If L is non-empty then do:
    Create a new public static boolean field “static_initialized” in T.
    Add the statement “T.static_initialized = false;” to a special method
      which is called by the runtime environment at program initialization.
    Create a new method IM in T with signature INIT_SIG;
    Create the AST representation of the statement “if(static_initialized)
      return; else static_initialized=true;” as C;
    Append C to the body of IM;
    For each element E of L, append E to the body of IM;
For each field use expression E in the AST, do:
  Let F be the field referred to by E;
  If F is static and F is not a constant variable (JLS §4.12.4) then do:
    Let U be the type declaring F;
    Create a sequenced expression SE;
    For each type T in U and its superclasses ordered by
    (if A extends B, B
      precedes A) where T declares a method IM with signature
      INIT_SIG,
      do:
        Create a method invocation I of IM on T;
        Append I to SE;
    If SE is non-empty, then do:
        Replace E in the parent of E with SE;
        Append E to SE.
For each static method M in the AST, do:
  For each type T in the list of the type declaring M and its superclasses
  ordered
    by (if A extends B, A precedes B), do:
    If T declares a method IM with signature INIT_SIG and IM ≠ M, do:
      Create a new statement S containing a method invocation of IM on
          T;
      Insert S as the first statement after any constructor invocation in the
          body of M;
For each constructor K in the AST, do:
  Let T be the type declaring K;
  If T declares a method IM with signature INIT_SIG then do:
    Create a new statement S containing a method invocation of IM;
    Insert S as the first statement after the super-constructor invocation in
      the body of K.
```

Out of Sequence Initialization

If the order in which a static initializer method is evaluated with respect to other static initializer methods does not have any effect on program state after evaluation, then code size may be reduced and performance improved by calling this initializer once at a point in the program prior to the first static access, rather than testing whether static initialisation has occurred and evaluating it if it has not at each static access.

Method

One example of a method for determining whether a static initializer may be evaluated out of sequence is as follows: If a class K declares no static blocks, and for all static field initializers in K, the initializing expression does not invoke any method or constructor or refer to any field or variable that is not a static field of the class K, and the static initializers of all superclasses of K may be evaluated out of sequence according to this method, then the static initializer of K may be safely evaluated out of sequence.

For all classes T in the AST where this is the case, use instead the following modified procedure:

```
Initialize ordered list L as empty;
For each element E of T in textual order do:
  If E is a static block, then:
    Remove E from T;
    Append E to L;
    Remove static modifier from E;
  Else if E is a static field declaration with a non-constant initializer
    expression X, then do:
    Remove X from E;
    Create an assignment node N whose left-hand side is a
      reference to the field declared by E, and right-hand side is X;
    Append a new statement containing the expression N to L;
If L is non-empty then do:
  Create a new method IM in T with signature INIT_SIG;
  For each element E of L, append E to the body of IM;
  Add an invocation of the method IM to the special method which is
    called by the runtime environment at program initialization.
```

### EXAMPLES

Examples are given as a pseudo-Java textual rendering of the AST, using C++ style to represent constructs that are not valid in Java.

Example Conversion

```
Before
class SI{
  SI( ){ super( ); }
  static int x = m( );
  static String y = “hello”;
  static List l = new ArrayList( );
  static{
    l.add(“world”);
  }
  static int m( ){return 3;}
}
class SO extends SI{ //no static inits
  SO( ){ super( ); }
}
class SE extends SO{
  SE( ){ super( ); }
  static int y = m( );
  static int else( ){ return 6; }
}
class C{
  int demo( ){
    return SI.x + SE.y;
  }
}
After
class SI{
  SI( ){ super( ); static_initializer( ); }
  static int x;
  static String y;
  static List l;
  static int m( ){ static_initializer( ); return 3;}
  public static boolean static_initialized;
  public static void static_initializer( ){
    if(static_initialized) return; else
    static_initialized=true;
    x = m( );
    y = “hello”;
    l = new ArrayList( );
    {
      l.add(“world”);
    }
  }
}
class SO extends SI{ // no static inits
  SO( ){ super( ); }
}
class SE extends SO{
  SE( ){super( ); static_initializer( );}
  static int y;
  static int else( ){
    SI.static_initializer( );
    static_initializer( );
    return 6; }
  public static boolean static_initialized;
  static void static_initalizer( ){
    if(static_initialized) return; else
    static_initialized=true;
    y = m( );
  }
}
class C{
  int demo( ){
    return (SI.static_initializer( ),SI.x) +
      (SI.static_initializer( ),SE.static_initializer( ),SE.y);
  }
}
class RuntimeInitializer{
void runtime_initialization_function( ){
  SI.static_initialized = false;
  SE.static_initialized = false;
}}
```

Example Out of Sequence Initializer

| May be evaluated out of sequence | May not be evaluated out of sequence |
|---|---|
| class K{ | class C{ |
| static int i = 1; | static int i = K.j; |
| static int j = 2 * i; | //K.j refers to other class |
| //ok, same class constant | static int t = m( ); |
| static String x = true?“T”:“F”; | //m( ) not constant |
| } | static{ //static block not ok |
| class Demo{ | ... |
| int demo( ){ | } |
| return K.i; | } |
| } | class Demo{ |
| } | int demo( ){ |
| | return C.i; |
| | } |
| | } |
| After Translation | After Translation |
| class K{ | class C{ |
| static int i; | static int i; |
| static int j; | static int t; |
| static String x; | public static boolean |
| public static void | static_initialized; |
| static_initializer( ){ | public static void |
| i = 1; | static_initializer( ){ |
| j = 2 * i; | if(static_initialized) return; |
| x = true?“T”:“F”; | else static_initialized=true; |
| } | i = K.j; |
| class Demo{ | t = m( ); |
| int demo( ){ | { |
| return K.i; | ... |
| } | } |
| } | } |
| class RuntimeInitializer{ | } |
| void | class Demo{ |
| runtime_initialization_func- | int demo( ){ |
| tion( ){ | return |
| K.static_initializer( ); | (C.static_initializer( ),C.i); |
| }} | } |
| | } |
| | class RuntimeInitializer{ |
| | void |
| | runtime_initialization_function( ){ |
| | C.static_initialized = false; |
| | }} |

Instance Initializer Conversion

The term instance initialisation component used in this description is to be understood to mean the initializer of an instance field, or a non static initilization block. The Java programming language allows many forms of initialization of an object instance. Instance variables may be declared with initializer expressions, and classes may specify instance initializer blocks (JLS §8.6). These initializers are executed in textual order during object construction immediately after the invocation of the super-constructor.

The C++ language has no equivalent construct to these forms of initialization. It is therefore necessary to convert these initializers in a Java program before they can be accurately represented by C++.

Conversion Procedure

An example of a conversion procedure is as follows:

```
Let INIT_SIG be the method signature “private void instance_init( )”
For each class T in the AST, do:
  Initialize ordered list L as empty;
  For each element E of T in textual order do:
    If E is an instance initializer block, then:
      Remove E from T;
      Append E to L;
    Else if E is a non-static field declaration with an initializer
    expression X,
      then do:
      Remove X from E;
      Create an assignment node N whose left-hand side is a
        reference to the field declared by E, and right-hand side is X;
      Append a new statement containing the expression N to L;
  If L is non-empty then do:
    Create a new method IM in T with signature INIT_SIG;
    For each element E of L, append E to the body of IM;
    For each constructor C in T, do:
      Create a new statement S containing a method invocation of IM;
      Insert S as the first statement after the super-constructor invocation
        in the body of C;
```

### EXAMPLE

Examples are given as a pseudo-Java textual rendering of the AST, using C++ style to represent constructs that are not valid in Java.

```
Before
class II{
  II( ){ super( ); }
  int x = m( );
  String y = “hello”;
  List l = new ArrayList( );
  {
    l.add(“world”);
  }
  int m( ){return 3;}
}
After
class II{
  II( ){ super( ); instance_initializer( ); }
  int x;
  String y;
  List l;
  int m( ){return 3;}
  public void instance_initializer( ){
    x = m( );
    y = “hello”;
    l = new ArrayList( );
    {
      l.add(“world”);
    }
  }
}
```

String Concatenation Operators

Where the target language doesn't have equivalent functionality for concatenating strings, appropriate modification is made to any string concatenation operators.

Java's String concatenation operation is supported by explicitly converting String concatenation operations to uses of the StringBuffer class as suggested by the Java Language Specification (§15.18.1.2). This conversion may be performed by for each sequence S of String concatenation operations s1+s2+s3+ . . . +sn in the AST, replacing S with the AST representation of “(new StringBuffer(s1).append(s2).append(s3) . . . append(sn).toString( ))”.

Class Merging

Programs in Java typically have deep class hierarchies. When translating to C++, deep class hierarchies result in large polymorphic method lookup tables (vtables), which adversely affect program size. In some cases, it is possible to merge classes together without sacrificing runtime size or altering polymorphic dispatch semantics.

Some cases of this safe class-merging are:
of an uninstantiated parent class into its single subclass;
of a interface into its only implementor; and
of a purely-static class which directly extends Object into any arbitrary class.

Merging Procedure

Parent and Subclass

An example of a procedure to merge uninstantiated classes with their single subclasses is as follows:

```
For each class SP in the AST ordered by the relationship
(if A extends B, B precedes A):
  If SP has precisely one subclass, SB, and
    there exists no new instantiation in the AST instantiating SP, then do:
    For each class element E in SP in reverse textual order, do:
      If E is a field F, then do:
        If the name of F conflicts with that of a field in SB, then:
          Rename F by adding a prefix “super$” to its name;
          For each field access U of F in the AST:
            Update U to the new name;
        For each field access U of F in the AST, if U is a super
          qualified field access, then:
          Remove the super qualifier from U.
        Remove F from SP;
        Prepend F to the class body declarations of SB;
      Otherwise, if E is a method M, then do:
        If M is a constructor whose signature conflicts with that of
          a constructor in SB then:
          Append the minimum number of boolean
            parameters n to the parameters of M such that
            the signature of M no longer conflicts;
          For each invocation C of M in the AST, append n
            instances of the false literal to the arguments of
            C.
        Otherwise, if M is a method whose signature conflicts
          with that of a method in SB, then:
          Rename M by adding a prefix “super$” to its
          name;
          For each invocation I of M in the AST, do:
            If I is static or I is within SP or SB, then:
              Update I to the new name.
        For each invocation V of M in the AST, do:
          If V is a super method or constructor invocation
            within SB, then convert V to a this invocation.
        Remove M from SP;
        Prepend M to the class body declarations of SB;
    Set the superclass of SB to the superclass of SP.
    For each interface I implemented by SP, if SB does not implement I,
      then add I to the interfaces implemented by SB.
    For each pair of types (P,B) where P is SP or an array type of SP
      and B is SB or an array type of SB with the same dimensionality
      as P:
      For each identifier expression TI (e.g. “System” in “System.out”)
        identifying the type P in the AST, do:
        Replace TI with an expression identifying the type B.
      For each type specification TT (e.g. type specified in
        field/method declaration, type-cast expression, etc.) of the type
        P in the AST, do:
        Replace TT with the type B.
    Remove class SP from the AST.
```

Interface and Single Implementor

An example of a procedure to merge an interface with a single implementor is as follows:

```
For each interface I in the AST:
  If there exists only one class C in the AST that implements I, and
    there exist no interfaces in the AST that extend I, then:
    For each pair of types (IT,CT) where IT is I or an array type of
      I and CT is C or an array type of C with the same dimensionality
      as IT:
      For each identifier expression E (e.g. “System” in “System.out”)
        identifying the type IT in the AST, do:
        Replace E with an expression identifying the type CT.
  For each type specification T (e.g. type specified in field/method
    declaration, type-cast expression, etc.) of the type IT in the
    AST, do:
    Replace T with the type CT.
Remove I from the interfaces implemented by C;
Remove interface I from the AST.
```

Pure Static Class with Instance Class

An example of a procedure to merge a purely static class with an instance class is as follows:

```
For each class C that directly extends Object in the AST:
  If C contains only static fields and methods, is never instantiated, and
    has no subclasses, then:
    Identify a target class T in the AST where the static initializer of C
      does not conflict with the static initializer of T.
    For each class element E in T in reverse textual order, do:
      If E is a field F, then do:
        If the name of F conflicts with that of a field in C, then:
          Rename F by adding a prefix “merge$” to its
        name;
          For each field access U of F in the AST:
            Update U to the new name;
        Remove F from C;
        Prepend F to the class body declarations of T;
        For each field access A of F in the AST, do:
          Replace the qualifying expression of A with an
            expression identifying the class T.
      Otherwise, if E is a constructor, then remove E from C;
      Otherwise, if E is a method M, then do:
        If the signature of M conflicts with that of a method in T,
          then:
          Rename M by adding a prefix “merge$” to its
          name;
          For each invocation I of M in the AST, do:
        Update I to the new name.
    For each invocation I of M in the AST, do:
      Replace the receiver expression of M with an
        expression identifying the class T.
Remove the class C from the AST.
```

A simple means of determining whether a pair of static initializers would conflict is to use the procedure described above in relation to static initialization conversion to determine if a static initializer may be evaluated out of sequence. If either initializer satisfies this procedure, then the pair will not conflict.

### EXAMPLES

Examples are given as a pseudo-Java textual rendering of the AST, using C++ style to represent constructs that are not valid in Java.

Parent and Child

| Before | After |
|---|---|
| class P { | class S { |
| public P( ) { | public S(boolean gen) { |
| super( ); | super( ); |
| } | } |
| public P(int conflict) { | public S(int conflict, boolean gen) { |
| super( ); | super( ); |
| } | } |
| public int instfield; | public int super$instfield; |
| public static int statfield; | public static int super$statfield; |
| public static void statmeth( ) | public static void super$statmeth( ) { |
| { | super$statmeth( ); |
| statmeth( ); | super$statfield = 5; |
| statfield = 5; | } |
| } | public void super$instmeth( ) { |
| public void instmeth( ) { | super$instfield = 6; |
| instfield = 6; | super$instmeth( ); |
| instmeth( ); | this.super$instmeth( ); |
| this.instmeth( ); | } |
| } | public S( ) { |
| } | this(3, false); |
| class S extends P { | } |
| public S( ) { | public S(int conflict) { |
| super(3); | this(false); |
| } | } |
| public S(int conflict) { | public int instfield; |
| super( ); | public static int statfield; |
| } | public static void statmeth( ) { |
| public int instfield; | statmeth( ); |
| public static int statfield; | S.super$statmeth( ); |
| public static void statmeth( ) | statfield = 5; |
| { | S.super$statfield = 5; |
| statmeth( ); | } |
| P.statmeth( ); | public void instmeth( ) { |
| statfield = 5; | instmeth( ); |
| P.statfield = 5; | this.instmeth( ); |
| } | this.super$instmeth( ); |
| public void instmeth( ) { | instfield = 1; |
| instmeth( ); | this.super$instfield = 2; |
| this.instmeth( ); | } |
| super.instmeth( ); | } |
| instfield = 1; | class Observer{ |
| super.instfield = 2; | public static void run( ){ |
| } | S s = newS( ); |
| } | S p = s; |
| class Observer{ | s.statfield = 6; |
| public static void run( ){ | S.statfield = 6; |
| S s = new S( ); | p.super$statfield = 6; |
| P p = s; | S.super$statfield = 6; |
| s.statfield = 6; | s.instfield = 6; |
| S.statfield = 6; | p.super$instfield = 6; |
| p.statfield = 6; | p.super$statmeth( ); |
| P.statfield = 6; | S.super$statmeth( ); |
| s.instfield = 6; | s.statmeth( ); |
| p.instfield = 6; | S.statmeth( ); |
| p.statmeth( ); | s.instmeth( ); |
| P.statmeth( ); | p.instmeth( ); |
| s.statmeth( ); | } |
| S.statmeth( ); | } |
| s.instmeth( ); | |
| p.instmeth( ); | |
| } | |
| } | |

Interface and Implementor

| Before | After |
|---|---|
| interface I{ | class C{ |
| int interfacemethod( ); | public int interfacemethod( ) { |
| } | return 6; |
| class C implements I{ | } |
| public int interfacemethod( ) | } |
| { | class Obs{ |
| return 6; | public void observe( ){ |
| } | C i = new C( ); |
| } | i.interfacemethod( ); |
| class Obs{ | } |
| public void observe( ){ | } |
| I i = new C( ); | |
| i.interfacemethod( ); | |
| } | |
| } | |

Pure Static Class and Other Class

| Before | After |
|---|---|
| class StaticHolder extends | class Someotherclass extends S{ |
| java.lang.Object{ | static int staticvariable = 6; |
| public StaticHolder( ){ | static int merge$staticmethod(int |
| super( ); | x){ return staticvariable=x; } |
| } | public Someotherclass( ){ |
| static int staticvariable = | super( ); |
| 6; | doSomething( ); |
| static int staticmethod(int | } |
| x){ return staticvariable=x; } | void doSomething( ){ |
| } | return; |
| class Someotherclass extends S{ | } |
| public Someotherclass( ){ | static int staticmethod(int |
| super( ); | x){ return x; } |
| doSomething( ); | } |
| } | class Observer{ |
| void do Something( ){ | static void observe( ){ |
| return; | int i = |
| } | Someotherclass.staticvariable; |
| static int staticmethod(int | int j = |
| x){ return x; } | Someotherclass.merge$staticmethod(3); |
| } | int k = |
| class Observer{ | Someotherclass.staticmethod(4) |
| static void observe( ){ | } |
| int i = | } |
| StaticHolder.staticvariable; | |
| int j = | |
| StaticHolder.staticmethod(3); | |
| int k = | |
| Someotherclass.staticmethod(4); | |
| } | |
| } | |

Inheritance of a Method Defined in an Interface

In the Java programming language, where a class C implements an interface I, it is not necessary for C to implement an abstract method M in I if C inherits a method whose signature matches M. In C++, the multiple inheritance mechanism does not permit implementation of abstract (pure virtual) methods by concrete methods inherited via a different inheritance path. It is therefore necessary to insert a “trampoline” method in C and/or its subclasses for each method in I that is inherited rather than implemented by C, which consists only of a super invocation for the same signature as itself which is returned if the return type of the method is not void.

Procedure

```
For each interface I in the AST, do:
  For each class C that directly implements I, do:
    For each method IM in I, do:
      If C is concrete then:
        If C does not implement a method matching the signature
        of IM, then:
          Create a trampoline for IM in C.
      Otherwise:
        If there exists a concrete class D, such that D is a
        subclass of C and D neither implements nor inherits from
        C or any subclass of C a method matching the signature
        of IM, then:
          Create a trampoline for IM in D.
```

Let the procedure to create a trampoline for a method M in a class C be defined as follows:

```
Create a method P in C with the same name, return and argument types
as M, naming the arguments arg1... argn.
Create a method invocation node I with super as the receiver, N as the
method name, and arg1...argn as the arguments;
If the return type of P is not void then:
  Create a return node whose argument is I, and insert it into the body of
Otherwise:
  Insert I into the body of P.
```

### EXAMPLES

Source in examples are given as a pseudo-Java textual rendering of the AST, using C++ style to represent constructs that are not valid in Java.

In the following situations, a trampoline method matching “int m( ){return super.m( );}”

is to be created in the classes C, Concrete1 and Concrete2.

Array Initialization Conversion

In the Java programming language, it is permitted to declare an array with an array initializer which specifies its initial contents. In C++, an array's contents may not be specified in this manner, so it is necessary to convert these initializers in a Java program before they can be accurately represented in C++.

Conversion Procedure

An example of a conversion procedure is as follows:

```
For each declaration of an array field or variable V of type T[ ] with an
array initializer I in the AST, do:
  Create a private method M in the class enclosing V with a unique name
    and return type T[ ];
  Create an invocation expression INV of M;
  Define the local procedure R on an array initializer IT returning a
  variable as:
    Create a local variable declaration LV with a unique name,
    of type T[ ],
      initialized by a new array creation of type T[ ] with length(IT)
      elements;
    Append LV to the body of M;
    For each element E in IT, do:
      Let i be the original index of E in IT;
      Remove E from IT;
      If E is an array initializer then:
        Evaluate R on E returning variable RV;
        Create an assignment expression statement A to index i in
          the array declared by LV of RV;
      Otherwise:
        If E is the null literal then:
          Create an assignment expression statement A of
            the null literal to index i in the array declared by
            LV;
        Otherwise:
          Create a new parameter P to M of the type of E;
          Append E to the arguments of INV;
        Create an assignment expression statement A to
          index i in the array declared by LV of the variable
          declared by P;
    Append A to the body of M;
  Return from R with the variable declared by LV;
Evaluate R on I returning variable RV;
Create a return statement of RV and append it to the body of M;
Replace I with INV in V.
```

### EXAMPLE

The example is given as a pseudo-Java textual rendering of the AST, using C++ style to represent constructs that are not valid in Java.

```
Before:
class C{
  Object[ ][ ] obs = {{“a”,“b”},new Object[3],{“y”}};
}
After:
class C{
  Object[ ][ ] obs = $arrayInit_Object_2D_1(“a”, “b”, new Object[3],
“y”};
  Object[ ][ ] $arrayInit_Object_2D_1(Object p1, Object p2,
            Object[ ] p3, Object p4){
    Object[ ][ ] ary1 = new Object[3][ ];
    Object[ ] ary2 = new Object[2];
    ary2[0] = p1;
    ary2[1] = p2;
    ary1[0] = ary2;
    ary1[1] = p3;
    Object[ ] ary3 = new Object[1];
    ary3[0] = p4;
    ary1[2] = ary3;
    return ary1;
  }
}
```

Constructor Virtualisation

In the Java programming language, method calls made on the object being constructed within the body of a constructor method are virtually dispatched. The C++ language does not permit virtual dispatch on an object while it is being constructed: the dispatch will only take place between the parts of the object that have been constructed so far, and therefore cannot take overriding subclass methods into account. To preserve Java semantics, it is necessary to convert the body of constructor methods into ordinary methods whose C++ representations support virtual dispatch.

Constructor Virtualisation Procedure

An example procedure for this conversion is as follows:

```
For each object class C in the AST, partially ordered by the
relationship (A extends B → A [symbol]  B), do:
  Create a new default constructor DM in C with no arguments or body;
For each constructor method M in C except DM, partially ordered by the
relationship (X invokes Y → Y [symbol]  X), do:
  Let VC be a new method in C with name “v_construct” and return type
  C;
  Move the argument parameters of M to VC, leaving M with no
  parameters;
  Move the body of M to VC;
  Append the AST representation of the statement “return this;” to VC;
  For each new instantiation N of C that resolves to constructor M, do:
    Create a new instantiation DN of DM;
    Create a method invocation I of VC on DN;
    Move the arguments of N to I;
    Replace N with I;
    Remove N;
  For each direct constructor invocation D resolving to M, do:
    Create a method invocation I of VC;
    If D is a super-constructor invocation, then:
      Add a super qualifier to I;
    Move the arguments of D to I;
    Replace D with I;
    Remove D;
  Remove M;
```

### EXAMPLE

Examples are given as a pseudo-Java textual rendering of the AST, using C++ style to represent constructs that are not valid in Java.

| Before | After |
|---|---|
| class C{ | class C{ |
| C( ){ | C( ){ super( ); } //default |
| this(3); | public C v_construct( ){ |
| } | v_construct(3); |
| C(int arg){ | return this; |
| super( ); | } |
| } | public C v_construct(int arg){ |
| } | super.v_construct( ); |
| class Observer{ | return this; |
| void observe( ){ | } |
| C c = new C( ); | } |
| C d = new C(6); | class Observer{ |
| } | void observe( ){ |
| } | C c = new C( ).v_construct( ); |
| | C d = |
| | new C( ).v_construct(6); |
| | } |
| | } |

Expression Order Correction

In the Java programming language, the order of evaluation of sub-expressions within an expression is fixed as left-to-right (Java Language Specification (3^{rd} edition), §15.7). In C++, there is no defined order in which sub-expressions must be evaluated, (The C++ Programming Language (Special edition), §6.2.2); with the exception of the sequenced expression (a,b), conditional expression (a?b:c), and short-circuiting Boolean operators (a∥b, a&&b), a C++ language implementation is free to choose an order of evaluation arbitrarily.

Therefore, in order to translate a Java expression into a C++ expression with the same evaluation semantics, it is necessary to transform the expression such that there remain no sub-expressions whose evaluation in differing orders could result in different program state after the evaluation of the parent expression.

Assignment expressions are a special case, as it is necessary to preserve the assignability of the I-value, or assignable program entity. This may be done by using an explicit pointer or reference, or by decomposing the left-hand side. In the latter method, we recognise that there are two distinct and separate ways a conflict can occur in an assignment expression: first, if the left-hand side expression of the assignment is a field access expression (a.b) there may be a conflict between the left hand part of the field access expression and the right-hand side of the assignment, which requires the left-hand side to be extracted and pre-evaluated; second, the variable being assigned may be itself be modified in the right hand side, which requires the right-hand side to be extracted and pre-evaluated. As evaluation of a variable itself has no side-effect, it is always unnecessary to extract the variable access component from the left hand side.

Expression Order Correction Algorithm

```
Let the procedure to extract conflicting expressions in an ordered list of expressions L
  from an enclosing expression z be defined as follows:
    Let U be the set of integers m for which there exists an integer p such that m <
      p ≦ length(L) and Lₘconflicts with Lₚ;
    If U is non-empty, then do:
        Create a new C++ sequenced expression, seq;
        Substitute seq for z in the parent of z;
        append z to seq;
        For each integer i in U, do:
            Create a fresh variable v of the type of Lᵢ within the current
              scope;
            Substitute a reference to v for Lᵢ in the parent of Lᵢ;
            Create an assignment a of Lᵢ to v;
            Insert a into seq such that a lies before z and before any
              assignment of an expression d where d initially occurred
              textually before Lᵢ.
For every assignment expression y in the program AST do:
    Let l be the left-hand sub-expression of y;
    Let r be the right-hand sub-expression of y;
    If l is an array access expression lx[idx₁][idx₂]..[idxₙ] then do:
        Let S be the list of expressions [lx, idx₁, idx₂, ...idxₙ, r];
        Extract conflicting expressions in S from y;
    Otherwise l is a field access expression ll.lr - do:
        If l conflicts with r, then do:
            create a new C++ sequenced expression, ss;
            Substitute ss for y in the parent of y;
            Add y to ss;
            Create a fresh variable v₁ of the type of r within the current
            scope; Substitute a reference to v₁ for r in y;
            Create an assignment a₁ of r to v₁;
            Prepend a₁ to ss.
        If ll conflicts with r, then do:
            Create a fresh variable v2 of the type of ll within the current
            scope;
            Substitute a reference to v₂ for ll in l;
            Create an assignment a₂ of ll to v₂;
            Prepend a₂ to ss.
For every non-assignment expression x in the program AST with n > 1 direct sub-
expressions, e₁, e₂, .. eₙ, in left-to-right lexical order, do:
    Extract conflicting expressions in the ordered list [e₁, e₂, .. eₙ] from x;
```

Conflict Detection

The two expressions, d and e are deemed to conflict as sub-expressions of a parent expression f if the result of their evaluation in differing orders during the evaluation of f can not be statically determined to not result in different program state after the evaluation of f. A trivial design of such an algorithm for this would be to assume that all expressions conflict with one another. A less trivial design is to perform a more detailed inspection of the expressions as follows:
An expression including a method call or thrown exception conflicts with any other expression.
An expression including a write to an array element conflicts with any read or write of any array element.
An expression including a write to a field or variable conflicts with any read or write of that field or variable.

### EXAMPLES

Examples are given as a pseudo-Java textual rendering of the AST, using C++ style to represent constructs that are not valid in Java.

Addition Expression

In this example, evaluation of a++ and a−− in differing orders would result in different values of the addition expression.

| Before | After |
|---|---|
| { ... | {int fresh1; ... |
| (a++ + a−−) | (fresh1=a++, fresh1 + a−−) |
| ... } | ... } |

Method Call

In this example, early evaluation of (var=otr) would change the object on which the method is invoked. otr is not extracted, as it conflicts with neither the use of nor the assignment to var.

| Before | After |
|---|---|
| { ... | {T1 fresh1, fresh2; ... |
| var.meth(otr, var=otr) | (fresh1=var, |
| ... } | fresh2=(var=otr), |
| | fresh1.meth(otr, fresh2)) |
| | ... } |

Assignment Altering Variable

In this example, the expression being assigned to ‘a’ changes the value of ‘a’.

| Before | After |
|---|---|
| { ... | {int fresh1; ... |
| a = a++ | (fresh1=a++, a=fresh1) |
| ... } | ... } |

Conflicting Field-Access Assignment

In this example, the evaluation of c( ) could affect the evaluation of b( ), and additionally could write to the field obtained by b( ).a.

| Before | After |
|---|---|
| { ... | { T1 fresh1; T2 fresh2; ... |
| b( ).a = c( ) | (fresh1 = b( ), fresh2 = c( ), |
| ... } | fresh1.a = fresh2) |
| | ... } |

Conflicting Array-Access Assignment

In this example, the evaluation of each method could affect the results of evaluating the others.

| Before | After |
|---|---|
| { ... | { T1 fresh1; int fresh2; T2 |
| b( )[a( )] = c( ) | fresh3; ... |
| ... } | (fresh1 = b( ), fresh2 = a( ), |
| | fresh3 = c( ), fresh1[fresh2] = |
| | fresh3) |
| | ... } |

Array Type Signature Modification

Arrays in the Java programming language are required to do more than their counterparts in C++. While a C++ array is little more than a contiguous block of memory, a Java array must provide element type and bounds checking, and be of a type extending Object with covariant subtyping with respect to the element type.

It would be possible to implement arrays with these features in C++ by creating array classes as C++ classes on demand for each Object array type used in the translated program. However, this method would result in significant code-size increase due to the many additional classes that would be required. This part of the application is directed towards representing all Java Object array types using a single C++ class.

Conversion Process

As different array types will no longer be differentiable by their type, it is necessary to modify the signatures of methods which come into conflict: a method x (String [ ]y) must be differentiable from a method with the same name, x(List[ ]y). A procedure to enable this differentiation is to modify the names of methods with object-array parameters with unique strings representing the types of their arguments. This can be done by appending ‘$’ and a hexadecimal representation of the CRC32 hash of the concatenation of the fully qualified Java type names of all object-array-typed parameters to the method name. This mangling may be done at any stage of translation.

### EXAMPLE

Java method signature
void arrayArgument(String[ ] strings)
void arrayArgument(Integer[ ] integers)
void manyArrayArguments(String[ ] s, String[ ][ ] ss, Integer[ ] i)
C++ method signature
void arrayArgument$807DC21D(JavaObjectArray* strings)
void arrayArgument$A206B381(JavaObjectArray* integers)
void manyArrayArguments$DEB7A436(JavaObjectArray* s,
JavaObjectArray* ss, JavaObjectArray* i)

Devirtualisation Optimisation

In the Java programming language, all non-private instance methods are subject to polymorphic method dispatch. In the C++ programming language, polymorphic method dispatch may be enabled by the programmer on a method-by-method basis, using the ‘virtual’ keyword. As polymorphic method dispatch has both code size and runtime overhead, it is therefore desirable to not use polymorphic method dispatch for those methods for which it can be guaranteed to be unused.

### EXAMPLE METHOD

An example of a procedure to detect methods that may be translated as non-virtual is as follows:

```
For each method M in the AST, do:
    If M is private, then M is non-virtual.
    Otherwise, if M is abstract, then M is virtual.
    Otherwise, if there exists a non-private method of the same signature
      as M in a class or interface C where C is a subtype of the class
      declaring M, then M is virtual.
    Otherwise, if there exists a non-private method of the same signature
      as M in a class or interface D where D is a supertype of the class
      declaring M, then M is virtual.
    Otherwise, M is non-virtual.
```

### EXAMPLE

| Java | C++ headers |
|---|---|
| class A{ | class A{ |
| private void ameth( ){ } | private: |
| abstract void anabsmeth( ); | void ameth( ); |
| public void apublicmeth( ){ } | public: |
| public void anothermeth( ){ } | virtual void anabsmeth( ) = |
| } | 0; |
| class B extends A{ | virtual void apublicmeth( ); |
| public void apublicmeth( ){ } | void anothermeth( ); |
| public void moremeth( ){ } | }; |
| public void evenmoremeth( ){ } | class B: public A{ |
| } | public: |
| class C extends B{ | virtual void apublicmeth( ); |
| public void moremeth( ){ } | virtual void moremeth( ); |
| public void lastmeth( ){ } | void evenmoremeth( ); |
| } | }; |
| | class C: public B{ |
| | public: |
| | virtual void moremeth( ); |
| | void lastmeth( ); |
| | }; |

The following procedures are carried out as part of the output stage when exporting the AST in the target language format.

Object Array Conversion

As explained above in the section dealing with array type signature modification, arrays in the Java programming language are required to do more than their counterparts in C++. While a C++ array is little more than a contiguous block of memory, a Java array must provide element type and bounds checking, and be of a type extending Object with covariant subtyping with respect to the element type.

It would be possible to implement arrays with these features in C++ by creating array classes as C++ classes on demand for each Object array type used in the translated program. However, this method would result in significant code-size increase due to the many additional classes that would be required. This part of the application is directed towards representing all Java Object array types using a single C++ class when providing an output from the AST.

Representation and Conversion Procedure

C++ Representation

The C++ representation of an object array must include the following information:
Array of pointers to Java object members
Length of the array
Runtime type identifier of the innermost element type
Number of inner array dimensions before innermost type

With this information, type and bounds checking may be done on store, instance of and cast operations. The C++ object array class is created with these fields, and methods for array creation, access, update and type checking.

Output Transformation

Additional transformation must also be done when outputting C++ code to conform to this model of arrays.

| | | |
|---|---|---|
| Creation | new T[3] | JavaObjectArray::create(3, TYPEID_T, 0) |
| Get | x[n] | CAST(elementtype(x), x->get(n)) |
| Store | x[n] = p | x->set(n, p) |
| Cast | (U[ ])x | ARRAYCAST(U, 1, x) |
| Type test | x instanceof | INSTANCEOF_ARRAYTYPE(x, T, 2) |
| | T[ ][ ] | |

The methods create, get and set on the JavaObjectArray type are equivalent to the Java array creation, access and assignment operations. The arguments to create are length, runtime type id of element type, and number of inner array dimensions before elements. The macros CAST and ARRAYCAST reproduce the functionality of the Java runtime-checked cast operation. The arguments to ARRAYCAST are element type, dimension and expression. The macro INSTANCE OF_ARRAYTYPE reproduces the functionality of the Java runtime type test operator instanceof for array types. The arguments to INSTANCEOF_ARRAYTYPE are expression, element type, and dimension. Two or more dimensional arrays are created using convenience methods that recursively use the JavaObjectArray::create method to create their element types, for example ObjectArray2dCreate(TypeID, elt_dim, first_dim, second_dim).

### EXAMPLE

```
Java Code
String[ ] x = new String[3];
String[ ][ ] s = new String[4][5];
s = new String[3][ ];
s[0] = new String[4];
x[0] = “hi”;
String t = x[0];
Object[ ] y = (Object[ ]) x;
if( y instanceof String[ ] ){
    return;
}
Translated C++ code
JavaObjectArray *x = JavaObjectArray::create(3,
TYPEID_java_lang_String, 0);
JavaObjectArray *s = ObjectArray2dCreate(TYPEID_java_lang_String,
0, 4, 5);
s = JavaObjectArray::create(3,TYPEID_java_lang_String, 1);
s->set(0, JavaObjectArray::create(4, TYPEID_java_lang_String, 0)));
x->set(0, java_lang_String::intern(“hi”));
java_lang_String *q = CAST(java_lang_String, x->get(0));
JavaObjectArray *y = ARRAYCAST(java_lang_Object, 1, x);
if (INSTANCEOF_ARRAYTYPE(y, java_lang_String, 1)) {
        return;
}
```

Exception Handling

The Java programming language provides a try/catch/finally exception model:
A try statement executes a block. If a value is thrown and the try statement has one or more catch clauses that can catch it, then control will be transferred to the first such catch clause. If the try statement has a finally clause, then another block of code is executed, no matter whether the try block completes normally or abruptly, and no matter whether a catch clause is first given control. (Java Language Specification 3ed §14.20)

In C++, exception support is compiler-dependent, and finally is not part of the C++ language. It is thus necessary to provide a mechanism to model the semantics of Java exceptions and the finally construct in C++.

Java Exception Simulation Procedure

Java's exception support is simulated by using C's setjmp/longjmp mechanism to jump from a throw to an enclosing catch, and finally is supported within non-exception control flow by modification of control structures in methods that include try blocks to enable evaluation of finally blocks on break, continue, and return. This code is preferably substituted for the Java constructs during the C++ output phase of AST processing.

It will be understood that setjmp/longjmp can be substituted by an equivalent pair of functions that saves the execution state of the program, and restores the execution state of the program. For example, setjmp/longjmp can be substituted by getcontext/setcontext as defined in the POSIX API.

Exceptions with Finally in Exception Case Control Flow

Exceptions are modelled using setjmp/longjmp to return to enclosing try blocks on the stack. At the entry to each try block, the point in the program is stored using setjmp; in the example method being saved on a stack of try locations. After the setjmp, control flow enters a do{ . . . }while(false) loop. In the case that the jump location has just been set, the try block is executed, and a break is used to escape the loop. Otherwise control has returned to the point of the setjmp via a longjmp at an exception throw, and the value returned represents the particular exception thrown. In this case the catch clauses are considered: if the exception matches a particular catch clause, then it is recorded that the exception has been caught, and a break used to escape the loop. If no catch blocks match the exception, then a flag is set indicating that the exception must be rethrown after executing the finally block and the loop exits.

At this point, which is reached whether control flow exits the try normally or via a caught or uncaught exception, the saved location is removed from the stack, and the finally block is evaluated. After evaluation, if the rethrow flag is set, then the exception is rethrown using longjmp. Even if a finally block is not declared, this surrounding code must still be included.

The following code segment shows how the syntactic elements of try{}catch{}finally{} are translated into the C++ representation. In this example, the following functions are defined:
push_new_try_location_jump_buffer( )—Creates a new jump buffer suitable for use with setjmp( ) and pushes it onto a global stack. The topmost element of this stack is accessible via the global pointer current_exception_jump_buffer. The top buffer is removed from the global stack with pop_try_location_jump_buffer( ).
non_-exception( ) returns true if the argument is not actually an exception, for example the zero-value returned by setjmp( ).
instanceof<T>(x)—reproduces the functionality of the Java instanceof operator to determine at runtime if x is an instance of the exception type T.

| | |
|---|---|
| try{ | { |
| A | bool caught_exception=false; |
| } | java_lang_Exception* exception = |
| catch(T t){ | setjmp(push_new_try_location_jump_buffer( )); |
| B | bool throw_after_finally=false; |
| } | do{ |
| catch(U u){ | if(non_exception(exception)){ |
| C | {A} |
| } | break; |
| ... | } |
| finally{ | if(!caught_exception && |
| D | instanceof<T>(exception)){ |
| } | caught_exception=true; |
| | {B} |
| | break; |
| | } |
| | if(!caught_exception && |
| | instanceof<U>(exception)){ |
| | caught_exception=true; |
| | {C} |
| | ... |
| | break; |
| | } |
| | throw_after_finally = true; |
| | } while (0); |
| | pop_try_location_jump_buffer( ); |
| | {D} |
| | if (throw_after_finally) |
| | longjmp(current_exception_jump_buffer, |
| | exception); |
| | } |
| throw(x); | longjmp(current_exception_jump_buffer, x); |

It will be understood that setjmp/longjmp can be substituted by an equivalent pair of functions that saves the execution state of the program, and restores the execution state of the program. For example, setjmp/longjmp can be substituted by getcontex/setcontext as defined in the POSIX API.

Enabling Finally in Non-Exceptional Control Flow

This procedure alone is insufficient to model finally behaviour in Java/C++ control flow: in code such as the following example, the break, continue and return statements could prevent the finally block from being executed or otherwise operate incorrectly.

```
while(0){
    try{
        if(x==1) break;
        else if(x==2) continue;
        else return 0;
    }
    finally{
        do_important_stuff( );
    }
}
```

Therefore, modifications to the above procedure are necessary to ensure the correct behaviour of finally in the presence of this type of control flow. This is done by modifying control flow constructs in all methods which use the try construct as follows:

| break; | {doReturn | = false; |
|---|---|---|
| | doContinue | = false; |
| | doBreak | = true; |
| | break;} | |
| continue; | {doReturn | = false; |
| | doContinue | = true; |
| | doBreak | = false; |
| | continue;} | |
| return(X); | {doReturn | = true; |
| | returnValue | = X; |
| | doBreak | = false; |
| | doContinue | = false; |
| | break;} | |
| return; | {doReturn | = true; |
| | doBreak | = false; |
| | doContinue | = false; |
| | break;} | |
| while(X){Y} | while(X){Y}{ | |
| | doBreak | = false; |
| | doContinue | = false; |
| | if(doReturn) break; | |
| | } | |
| Other loop construct Z | Z{ | |
| | doBreak | = false; |
| | doContinue | = false; |

| | if(doReturn) break; |
|---|---|
| | } |
| Append to end of Finally block | if(doBreak) break; |
| | if(doReturn) break; |
| | if(doContinue) continue; |
| Around entire non-void (return type T) | bool doReturn = false; |
| method body B: | bool doBreak = false; |
| | bool doContinue = false; |
| | T returnValue = 0; |
| | do{ |
| | B |
| | }while(0); |
| | return returnValue; |
| Around entire void method body B: | bool doReturn = false; |
| | bool doBreak = false; |
| | bool doContinue = false; |
| | do{ |
| | B |
| | }while(0); |

The result of these modifications is that a break or continue operation within the body of a try/catch or finally loop will be repeated after each finally block reached until a non-try loop (the original target) is encountered, while a return operation will break repeatedly from every loop it encounters, executing finally blocks as it passes them, until it reaches the loop enclosing the method body, and the actual return operation is performed.

### EXAMPLE

```
Before
int aMethod(int i){
    while(true){
        try{
            if(i == 1) break;
            if(i−− == 2) continue;
            if(i == 3) return i;
            else throw new Exception( );
        }
        catch(Exception e){
            return 10;
        }
        finally{
            i = 6;
        }
    }
    return i+1;
}
After (C++)
int aClass::aMethod(int i){
    bool doReturn = false;
    bool doBreak = false;
    bool doContinue = false;
    int returnValue = 0;
    do{
    while(true){
        {
        bool caught_exception=false;
        java_lang_Exception* exception =
          setjmp(push_new_try_location_jump_buffer( ));
        bool throw_after_finally=false;
        do{
          if(non_exception(exception)){{
            if(i == 1){
              doReturn = false;
              doContinue = false;
              doBreak = true;
              break;
            }
              if(i−− == 2){
              doReturn = false;
              doContinue = true;
              doBreak = false;
              continue;
            }
            if(i == 3){
              doReturn = true;
              returnValue = i;
              doBreak = false;
              doContinue = false;
            }
            else longjmp(current_exception_jump_buffer,
                    (new java_lang_Exception( ))->v_construct( ));
        }
        if(!caught_exception &&
            instanceof<java_lang_Exception>(exception)){
              caught_exception = true;
              {
                {
                  doReturn = true;
                  returnValue = 10;
                  doBreak = false;
                  doContinue = false;
                }
            }
            break;
        }
        throw_after_finally = true;
        while(0);
        pop_try_location_jump_buffer( );
        {
            i = 6;
        }
        if(throw_after_finally)
            longjmp(current_exception_jump_buffer, exception);
        }
        if(doBreak) break;
        if(doReturn) break;
        if(doContinue) continue;
    }
    { doBreak = false;
      doContinue = false;
      if(doReturn) break; }
    { doReturn = true;
      returnValue = i+1;
      doBreak = false;
      doContinue = false;
      break; }
  }while(0);
  return returnValue;
}
```

### Further Embodiments

The current invention is also equally applicable to the development of embedded software, where a Java virtual machine may not be available. Java is a highly productive language as it eliminates classes of common programming mistakes such as dangling pointers. Through applying the current invention, a software developer can develop in Java, and then translate to C or C++, which are the dominant computer languages for embedded software development.

It will be appreciated that Java Micro Edition and C# share many common language features, constructs, syntax, and philosophy. Through applying the methods described above, a software developer is able to develop in C#, and then translate to C or C++. The majority of the methods described in the embodiment are equally applicable if the programming language is originally in C# rather than Java.

It will further be appreciated that the invention may be used on C type languages other than those specifically disclosed. For example, Objective C may be used as a target language in the methods described herein.

The foregoing describes the invention including a preferred form thereof. Alterations and modifications as will be obvious to those skilled in the art are intended to be incorporated within the scope thereof as defined in the accompanying claims.

It will be understood that the program structure representation can be representative of the program in source code or any other suitable format.

It will be further understood that the process described herein could be applied to translating from a first programming language to a subset of that programming language that relates to functionality that can be implemented using the target programming language being translated to.

It will be further understood that the methods described herein may be implemented using one or more programs.

It will be appreciated that methods other than those specifically described in the embodiments may be used to carry out the transformations required.

1. A computer implemented method for automatically translating a first source code associated with a first programming language to a second source code associated with a second programming language wherein the first and second source codes are associated with the same functionality, the method comprising the steps of:
parsing the first source code to form a program structure representation comprising a plurality of program structure elements associated with the first programming language,
analysing the program structure elements, wherein the analysis includes the step of searching for at least one program structure element that has no direct associated representation that produces the same result in the second programming language, and
transforming the program structure representation into the second source code based on said analysis.

2. The method of claim 1, further comprising the steps of:
detecting at least one program structure element during the analysis step, and
transforming the detected program structure element into a transformed program structure element that can be represented in the second programming language.

3. The method of claim 1, wherein the first programming language is a programming language from the group comprising: Java; Java Micro Edition; C#; a language derived from Java; a language derived from C#, and the second programming language is a programming language from the group comprising: C; C++; a language derived from C; a language derived from C++.

4. The method of claim 3, where the second source code is for a target platform from the group comprising: BREW; Symbian; Windows CE.

5. The method of claim 1, wherein the program structure representation comprises an abstract syntax tree constructed from the first source code.

6. The method of claim 5, wherein a separate abstract syntax tree is constructed for a single class.

7. The method of claim 1, wherein the program structure representation comprises class hierarchy information constructed from the first source code.

8. The method of claim 3, wherein the second programming language is a programming language from the group comprising: C; C++; a language derived from C; a language derived from C++, and the method further comprises the steps of:
compiling the second source code into a target object code, and linking the target object code with a first set of run-time libraries associated with the second programming language, wherein the first set of run-time libraries provide at least some of the capabilities of a second set of run-time libraries associated with the first programming language.

9. The method of claim 5 further comprising the steps of:
analysing the program structure elements to identify expressions containing sub-expressions where the direct associated representation of the expression in the first programming language requires the sub-expressions to be executed in a specific order, but the direct associated representation of the expression in the second programming language does not, and
converting an identified expression such that in the direct associated representation in the second programming language of the converted expression, the sub-expressions are executed in the specific order.

10. The method of claim 9, wherein the sub-expressions are required to be operated on in the order from left to right.

11. The method of claim 10, wherein the expression is a binary operator.

12. The method of claim 10, wherein the sub-expressions are an argument list.

13. The method of claim 12, wherein the argument list forms part of a method or constructor invocation.

14. The method of claim 9, wherein the expression comprises a first set of sub-expressions, and the expression is expressible in both the first and second programming language as one of the group comprising: language-defined operator; language-defined function; application-defined function, the method further comprising the steps of:
extracting a first set of sub-expressions from the expression, and
creating a new expression comprising the extracted sub-expressions such that the direct associated representation in the second programming language of the new expression produces the same result when executed as the execution of the direct associated representation of the original expression in the first programming language.

15. The method of claim 14 further comprising the step of using a temporary variable to store a result of one of the first set of sub-expressions.

16. The method of claim 15 further comprising the steps of:
combining into the new expression, using the C sequence operator, one or more assignments to a temporary variable storing the result of a sub-expression of the first set in the required order of execution, and
transforming the original expression with the sub-expression replaced by its corresponding temporary variable.

17. The method of 14 further comprising the step of:
analysing the sub-expressions to determine if they are sensitive to the order in which they are evaluated and, upon a positive determination, creating the new expression.

18. The method of claim 3, wherein the second programming language is C++, or a language derived from C++, the method further comprising the steps of:
analysing the program structure representation to find a constructor method, wherein the constructor method is associated with a first class and a first set of parameters,
creating a new method in the first class that has equivalent parameters to the first set of parameters,
moving the logic embodied in the constructor method into the newly created method, and
replacing an expression that instantiates the first class using the constructor and a set of arguments with an expression that instantiates the first class with a constructor and invokes the newly created method on the instantiated result with the set of arguments.

19. The method of claim 3, wherein the second programming language is C++, or a language derived from C++, the method further comprising the step of:
analysing the program structure representation to find an interface, wherein a class implements the interface, super-classes of the class do not implement the interface, the interface declares a method of a method signature, and the class does not define a method of the method signature, and there exists a super-class of the class that does define a method of the method signature.

20. The method of claim 19 the method further comprising the step of:
adding to the class a method with the method signature the behaviour of which is to invoke the method of the method signature in the super-class.

21. The method of claim 19 the method further comprising the steps of:
determining if the class is an abstract class, and, upon a positive determination, and
adding to a concrete subclass of the class a method with the method signature the behaviour of which is to invoke the method of the method signature in the super-class.

22. The method of claim 3 wherein the second programming language is C++, or a language derived from C++, the method further comprising the steps of:
analysing the program structure representation to find a nested class,
extracting the nested class from an enclosing class to a non-nested class, and
associating the extracted nested class with the previously enclosing class.

23. The method of claim 22, wherein the extracted nested class is associated with the previously enclosing class by marking each class as a friend of the other.

24. The method of claim 23 further comprising the steps of:
analysing the program structure representation to find an inner class associated with the first source code,
modifying the inner class by adding a field referring to the previously enclosing class, and
adding additional parameters to constructor methods of the inner class denoting the outer class.

25. The method of claim 24, wherein where the inner class is a local inner class or anonymous inner class, the method further comprises the step of adding extra construction parameters and fields to the inner class denoting the final local variables of the enclosing method.

26. The method of claim 3, wherein the second programming language is C++, or a language derived from C++, the method further comprising the steps of:
analysing the program structure representation to find an array initializer, and upon finding, and
transforming the array initializer to a form suitable for representation in the second source code.

27. The method of claim 26 further comprising the steps of:
creating a method that creates an array, initializes the contents of the created array using parameters to the method corresponding to the elements contained in the array initializer, and returns the created array, and
replacing the array initializer with an invocation of the method, the arguments of which are the original elements contained in the array initializer.

28. The method of claim 3, wherein the second programming language is C++, or a language derived from C++, the method further comprising the steps of:
analysing the program structure representation to identify the use of any non-primitive arrays of any dimension associated with the first source code, and
replacing references to any non-primitive array types associated with the first source code with references to a class representing more than one non-primitive array types, wherein the class is associated with the second source code.

29. The method of claim 28, wherein an instance of the class contains information pertaining to an element type and dimension of the array it represents.

30. The method of claim 28, further comprising the step of:
modifying the signature of methods with one or more parameter types or return type which is a non-primitive array type, resulting, after the replacement of references, in a signature that is based on the original declared element type and dimension of each of the non-primitive array type parameter or return types in order to eliminate or reduce the possibility of name conflicts.

31. The method of claim 29 further comprising the step of:
replacing: creations of reads from, writes to or type test and cast operations on instances of non-primitive array types associated with the first source code with expressions performing an equivalent operation on the non-primitive array class associated with the second source code.

32. The method of claim 1, the method further comprising the steps of:
analysing the program structure representation to find any static initialization component associated with the first source code,
modifying the static initialization component to create a representation suitable for the second programming language, and
invoking the modified static initialization component.

33. The method of claim 1, the method further comprising the steps of:
analysing the program structure representation to find any static initialization component for a class associated with the first source code,
modifying the class by adding a method to the class, the method having the same function as the static initialization component,
removing the static initialisation component, and
finding a location involving use of static fields of the class, invocation of the static methods of the class or an instantiation of the class.

34. The method of claim 33, whereupon finding a static initialization component, the method further comprises the steps of:
inserting instructions immediately before the location to determine whether the class has completed static initialisation, and if static initialisation has not been completed,
invoking the added method, and
registering that the class has completed static initialisation.

35. The method of claim 34 further comprising the step of:
determining if the static initialization component has any effect that would result in different behaviour of the program if it were evaluated at a point in program
execution other than the first encounter of one of the locations of claim 34, and, upon a positive determination, causing the static initialization component to be evaluated at a different time.

36. The method of claim 1 further comprising the steps of:
analysing the program structure representation to find any instance initialization component associated with the first source code,
modifying the instance initialization component to create a representation suitable for the second programming language, and
invoking the modified instance initialization component.

37. The method of claim 36 further comprising the steps of:
analysing the program structure representation to find any instance initialization component for a class associated with the first source code,
modifying the class by adding a method to the class, the method having the same function as the instance initialization component,
removing the instance initialization component, and
inserting an invocation of the method at the beginning of a constructor.

38. The method of claim 7 further comprising the steps of:
analysing the program structure representation to find class hierarchies containing original classes associated with the first source code, and, if found,
modifying the original classes to merge classes together in order to reduce the number of classes associated with the second source code.

39. The method of claim 38 further comprising the steps of:
determining if the original classes can be merged to form a second source code that has substantially the same functionality as the first source code, and upon a positive determination,
modifying the program structure representation to merge the original classes to form a new single class by moving the class elements, and
modifying any references to the original classes such that they refer to the new single class.

40. The method of claim 39, wherein the original classes are merged such that a first original class is merged into a second original class.

41. The method of claim 40, wherein it is determined whether elements in the first original class conflict with elements in the second original class.

42. The method of claim 39, wherein the original classes are merged such that first and second original classes are merged into a new class.

43. The method of claim 42, wherein it is determined whether elements in the first original class conflict with elements in the second original class.

44. The method of claim 39 further comprising the steps of:
determining if the original classes to be merged include a class and its direct super-class, and the direct super-class has only one subclass and is non-instantiated, and, upon a positive determination,
merging the super-class and class, and
replacing references to the class and the super-class with reference to the merged class.

45. The method of claim 39, wherein an interface is considered a class, the method further comprising the steps of:
determining if the original classes to be merged include a class and an interface that the class directly implements, wherein the interface is directly implemented by the class or its subclasses, but not directly implemented by any other classes, and the interface is not extended by any other interfaces, and, upon a positive determination,
merging the interface with the class,
replacing references to the interface with references to the class, and
removing the implementation of the interface from any subclass that implements the interface.

46. The method of claim 39 further comprising the steps of:
determining if the original classes to be merged include a first class and a second class, wherein the first class is a direct subclass of a root class of the class hierarchy, the second class is not an interface, and the first class has no non-static fields, no non-static methods and no subclasses,
further determining by static analysis if a class initializer associated with the first class has no side-effects, or can be performed such that it would result in different program behaviour if it were evaluated in a different order with respect to the class initializer associated with the second class, and, upon positive determinations,
merging the first and second classes, and
replacing references to the first class and the second class with references to the merged first and second classes.

47. The method of claim 8, wherein the first set of run-time libraries include an implementation of automatic garbage collector.

48. The method of claim 8, wherein the first set of run-time libraries include a co-operative thread scheduler.

49. The method of claim 1, wherein the second source code retains the comments from the first source code by transforming the comments in the program structure representation to a format associated with the second source code.

50. A computer implemented method for automatically translating an exception functionality in a first source code associated with a first programming language to an equivalent exception functionality in a second source code associated with a second programming language wherein the first and second source codes are associated with the same functionality, the method comprising the steps of:
analysing a program structure representation of a first source code in order to find a program structure element that is associated with an exception functionality,
determining if the analysis step has found an exception functionality, and, upon a positive determination, and
converting the exception functionality to a suitably equivalent exception functionality in the second source code.

51. The method of claim 50, wherein the order in the second source code of any components of the converted exception functionality is the same as the order in the first source code of the equivalent components of the exception functionality.

52. The method of claim 51, wherein the elements of the exception functionality are contiguous in the first source code, and the elements of the converted exception functionality in the second source code are contiguous in the second source code.

53. The method of claim 50 wherein the first programming language is Java and the exception functionality in the first source code is a try/catch/finally statement.

54. The method of claim 50 further comprising the steps of:
determining if there exists an occurrence of control flow which would exit a try region and cause a finally region to be executed in the first programming language, and, upon a positive determination,
using in the second source code one or more means of storage to record the type of control flow, including a continue, break or return expression or an exception, by which the try region was exited,
executing instead the finally region, and subsequently using the stored information to provide equivalent functionality of control flow in the second source code as the functionality when the finally block exits in the first source code.

55. The method of claim 54 further comprising the steps of:
saving the original control flow immediately before an expression establishing the original control flow by means of at least one of the functions in a group consisting of: setjmp( ) in the C programming language; getcontext( ) in the POSIX API for the C programming language; a function producing substantially the same effect as setjmp( ) or getcontext( ); and
resuming the original control flow after the finally region is executed to return to the expression establishing the original control flow by means of at least one of the functions in a group consisting of: longjmp( ) in the C programming language; setcontext( ) in the POSIX API for the C programming language; a function producing substantially the same effect as longjmp( ) or setcontext( ).

56. The method of claim 50, wherein the means of storage include one of a field or a local variable.

57. The method of claim 50 further comprising the step of:
converting the try/catch/finally statement to a mechanism in the second source code using a method to store the current state of the program and a method to restore the state.

58. The method of claim 50 further comprising the step of:
converting the try/catch /finally statement to a mechanism in the second source code using one of the group consisting of: setjmp( ) in the C programming language; longjmp( ) in the C programming language; setcontext( ) in the POSIX API for the C programming language; getcontext( ) in the POSIX API for the C programming language.

59. The method of claim 50 further comprising the step of:
defining any local variables modified inside the try block in the first source code as volatile local variables in the second source code.

60. The method of claim 1 wherein the second programming language is C++, or a language derived from C++, the method further comprising the steps of:
determining if, for a method of a method signature in a first class, a method invocation of that signature on an object reference whose declared type is the type of the first class could result in polymorphic method dispatch to any method other than the method, and, upon a negative determination,
translating the method to a translated method in the second source code that is not marked as virtual.

61. The method of claim 60, wherein the determination step further comprises:
determining whether the method is not private, not abstract, and there exists no non-private method of the method signature in any class or interface that is a supertype or subtype of the first class.
